(19) United States
(12) Patent Application Publication
(10) Pub. No.: US 2001/0052346 A1
(43) Pub. Date: Dec. 20, 2001

(54) A PROCESS OF FEEDING A TOBACCO STREAM, A HOPPER AND A MACHINE EQUIPPED WITH A HOPPER

(76) Inventors: DAVID VUILLEUMIER, COLOMBIER (CH); BERNARD TALLIER, CORTAILLOD (CH)

Correspondence Address: BURNS DOANE SWECKER & MATHIS L L P, POST OFFICE BOX 1404, ALEXANDRIA, VA, 22313-1404, US

(21) Appl. No.: 09/189,802

(22) Filed: Nov. 12, 1998

(30) Foreign Application Priority Data
Dec. 11, 1997 (EP) EP 97810862-9

(51) Int. Cl. A24C 5/18; B65G 13/02; B65G 15/42

(52) U.S. Cl. 131/109.1; 131/109.2; 131/110; 131/108; 131/84.1; 209/639; 198/689.1

(57) ABSTRACT

A hopper is connected with a machine for manufacture of tobacco industry products including a tangential separator sequentially feeding an entry stock of the hopper. The distribution between portions of tobacco streams including a large proportion of short tobacco fibers and portions including a large proportion of long tobacco fibers of the tobacco stream set apart in advance in the entry stock is essentially longitudinal when the stream arrives on a transfer belt of the hopper. By imposing a change of direction on the tobacco stream as well as a reduction of speed of displacement of this stream, this longitudinal distribution is transformed into a transverse distribution. A spiked or barbed roller, placed at a right angle to this latter stream, homogenizes the distribution, making it possible for the distribution to be regular between short fibers and long fibers in the tobacco stream arriving through the chimney for the manufacture of the tobacco rod.

The present application claims priority to EP 97810862.9, filed Nov. 12, 1997, the disclosure of which is hereby expressly incorporated in its entirety.

### BACKGROUND AND SUMMARY

This invention concerns the feeding of tobacco in a machine for the manufacture of products of the tobacco industry, namely, a feeding process of a tobacco stream, a hopper able to work according to this process, and a cigarette-making machine equipped with the hopper.

In general, a hopper feeds with tobacco that part of the machine in which the tobacco is formed into a rod, by vacuum along the suction belt, in order to ultimately form a cigarette.

Preferably, such a hopper must feed that part of the machine as regularly as possible, which means that the tobacco in the tobacco stream feeding the making machine must have an even density: respectively, a distribution of its components, namely, a regular distribution of the long fibers and short fibers as well as a steady flow, so that in the tobacco rod being formed generally under a suction belt, both the longitudinal density and the distribution of the components are as even/regular as possible. In view of the fact that the bulk tobacco feeding the hopper is composed of a mixture of different components—long and short fibers of natural tobacco and/or reconstituted tobacco and/or homogenized tobacco and/or expanded tobacco, tobacco dust, ribs and winnowers from thick or thin section as well as whatever eventual wastes—another function of such a hopper is to eliminate specific components, namely: the midribs and winnowers of thick section as well as the wastes, while the tobacco dust is eliminated by the eventual hopper entry as well as through the suction belt where the tobacco rod is formed.

The numerous hoppers proposed till now do not enable feeding tobacco as regularly as required for rod forming. Another drawback of the current hoppers lies in their complexity, particularly in the complexity of the tobacco fiber stream and/or the treatment imposed on the tobacco which creates jams or choke-up and fiber quality deterioration, respectively, a decrease in the average fiber length and a humidity loss when separating is to be done with one or more air blowings. Moreover, the machines currently being used do not enable eliminating undesirable components efficiently but do simultaneously eliminate a great deal of fibers that could well be used in the manufacture of tobacco industry products. This will result in a direct production loss unless additional complex and costly means are available for recuperating such excessive fiber loss.

A first aim of this invention therefore is to provide a tobacco feeding process that overcomes these aforementioned drawbacks, and thus, enable steady tobacco feeding having a regular component distribution for rod forming.

A second aim is to provide a process using a gentle mechanical means of tobacco deblending, able to avoid jams and choke-ups, fiber quality deterioration and tobacco humidity loss.

A third aim is to provide a process able efficiently to eliminate any undesirable components.

A fourth aim is to provide a hopper able to function according to this process.

Lastly, a further aim of the invention is to provide a machine for manufacture of tobacco industry products, namely cigarettes, in which such a hopper is incorporated.

One or more of the foregoing aims are preferably accomplished through the present invention.

According to one aspect of the present invention, a process of feeding a tobacco stream from an entry stock of a hopper towards a suction chimney of a manufacturing machine for products of the tobacco industry is provided. According to the method, a tobacco stream having repeating, successive portions, a first portion of the portions having a high proportion of short tobacco fibers and a second portion of the portions having a high proportion of long tobacco fibers longer than the short tobacco fibers, is moved in a first direction and a at first speed to a transfer means. The tobacco stream is supplied to a conveyor moving in a second direction and at a second speed such that the tobacco stream has a form of a plurality of layers, at least one layer of the layers being a layer of short tobacco fibers and at least one layer of the layers being a layer of long tobacco fibers.

According to another aspect of the present invention, a hopper for a manufacturing machine for products of the tobacco industry is provided. The hopper includes a stock for holding tobacco, the tobacco including short tobacco fibers and long tobacco fibers longer than the short tobacco fibers. The hopper further includes a first conveyor having a movable first conveyor surface for transporting a tobacco stream from the stock of tobacco in a first direction, the first conveyor surface being movable at a first speed, such that the tobacco stream is in a form of repeating, successive portions, a first portion of the portions having a high proportion of the short tobacco fibers and a second portion of the portions having a high proportion of the long tobacco fibers, the first conveyor transporting the tobacco stream to an end of the first conveyor. The hopper further includes a second conveyor, the second conveyor having movable second conveyor surface extending between a first end and a second end, the first end being disposed proximate the end of the first conveyor and being arranged relative to the first conveyor to receive the tobacco stream from the end of the first conveyor so that the tobacco stream has a form of a plurality of layers, at least one layer of the layers being a layer of short tobacco fibers and at least one layer of the layers being a layer of long tobacco fibers, the second conveyor surface extending in a second direction and being movable at a second speed, the second direction and the second speed being different than the first direction and the first speed.

### BRIEF DESCRIPTION OF THE DRAWINGS

The following description of a hopper, in the form of a specific operating procedure according to the invention, is to be taken into consideration in regard to the enclosed drawings, wherein:

FIG. 1 is a schematic, cross-sectional view of an elevated machine for manufacture of tobacco industry products according to an embodiment of the present invention;

FIG. 2 is a schematic view showing the distribution of the tobacco on a comb belt of the hopper according to an embodiment of the present invention;

FIG. 3 is a schematic view showing the tobacco stream from the comb belt on an transfer belt of the hopper according to an embodiment of the invention; and

FIG. 4 is a schematic view showing the flow of the tobacco stream from the transfer belt toward a transfer channel according to the present invention.

### DETAILED DESCRIPTION

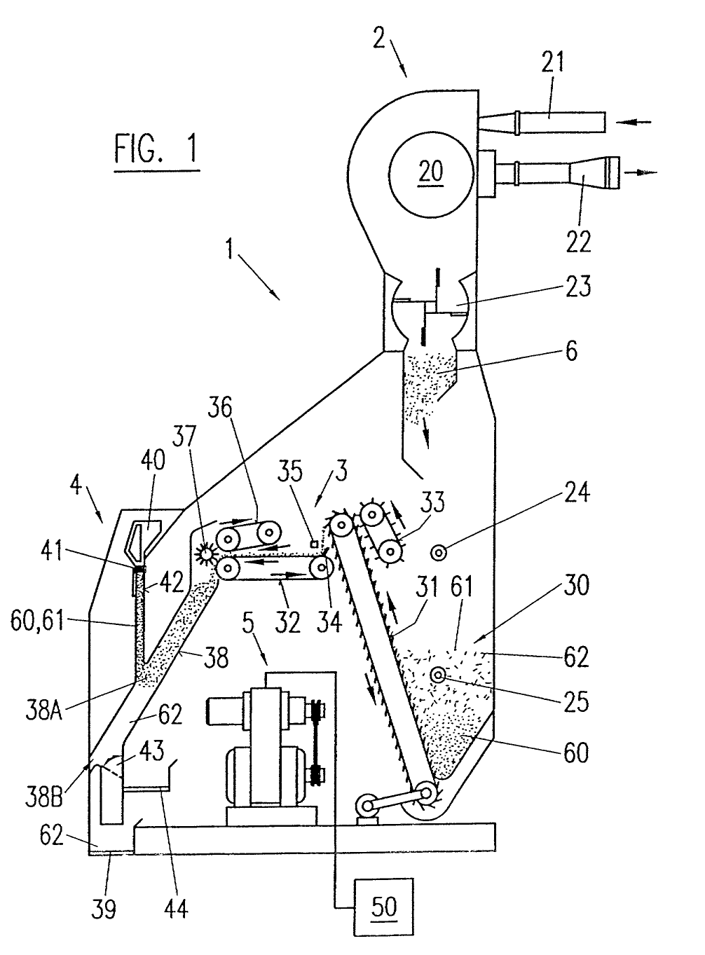

The machine for manufacture of tobacco industry products 1 represented in FIG. 1 comprises namely a part of tobacco feeding 2, a part of distribution or hopper 3, a part of rod forming 4, a part of drive and control 5.

Tobacco feeding 2 is basically meant to transport the tobacco 6 from a general stock not represented to an entry stock 30 of the hopper 3. Tobacco feeding 2 can be constituted from any type of known device, either a device being fed by a continuous belt, by lots or other sources. Preferably however, tobacco feeding 2 is comprised of a tangential lock such as described, for example, in either Patent EP-B-0.501.910 or Patent EP-B-0.655.402. In general, such a tangential lock 2 is comprised of a suction part 20 drawing up pneumatically a tobacco stream by channel 21 and separating the air having served in transporting the tobacco stream, air loaded in part with tobacco dust expelled by the channel 22; the other aforementioned tobacco stream components, passing by the stock 23 are sequentially unloaded in the entry stock 30. Two detectors, preferably optic cells 24 and 25 control the operating of the tangential lock 2 so that the entry stock 30 can be correctly fed without any obstruction.

The hopper 3, comprising a continuous comb belt 31 that stretches over most of the machine width, is in charge of taking the tobacco from the entry stock 30 to a continuous transfer belt 32. A first means of equalizing, for example, a continuous equalizing belt 33 placed close to the top of the comb belt 31, is in charge of carrying out a first equalization of the tobacco stream carried by the comb belt 31, respectively, to eliminate any excessive thickening of the tobacco stream there. A deflector 34 then drives the tobacco stream according to a first direction predetermined on the transfer belt 32. A detection cell 35 checks the quantity of tobacco arriving on the transfer belt 32 and drives the speed of the comb belt 31 respectively, from the transfer belt 32 in order to maintain a minimum tobacco stream predetermined on the transfer belt 32. A second means of equalizing, for example, a second continuous equalizing belt 36 in charge of slightly compacting and equalizing the tobacco stream, is placed near the end of the tobacco stream way on the transfer belt 32. A means of deblending, preferably a spiked or barbed roller 37, is placed slightly below the transfer belt 32 so as to deblend, mix and give expansion to the tobacco stream before the latter goes down, mostly by gravitation, into a transfer channel 38.

After having been fed into the entry stock 30, the tobacco 6 tends to separate in such a way that the lower portion of the entry stock 30 is filled mainly by short tobacco fibers 60 whereas the upper portion of the entry stock 30 is comprised mostly of long tobacco fibers 61. The midribs, winnowers and wastes 62 brought in with the tobacco stream are found mostly in the upper portion comprised of the long tobacco fibers 61.

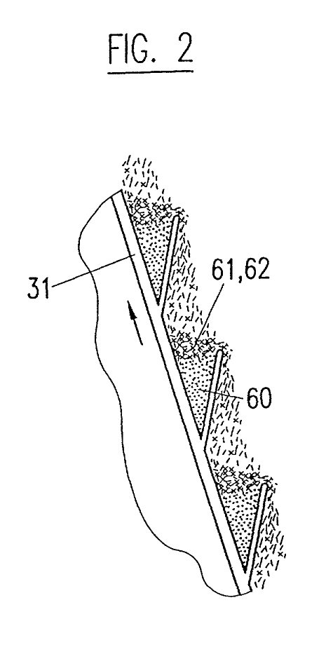

Referring to FIGS. 2, 3, and 4, the detailed functioning of the aforementioned components of the hopper 3 is shown. The comb belt 31 takes the tobacco from the bottom of the entry stock 30 by filling the spaces situated between two consecutive combs. In view of the distribution between the short fibers 60 and the long fibers 61 in the stock 30, as well as the slanting position of each comb relative to the belt 31 as seen in FIG. 2, the portion of this space between the two branches of the corner is filled in the lower portion of the stock 30, mainly with short fibers 60 of a relatively high tobacco-fiber density; on the other hand, the portion of the space directly behind the preceding comb is filled in the upper portion of the stock 30 with mainly long fibers 61. Moreover, owing to the length of the long tobacco fibers and their adhesion together, a certain quantity of long tobacco fibers exceeds the upper edges of the combs and, with a relatively low density, fills the portion of space that is directly behind the preceding comb.

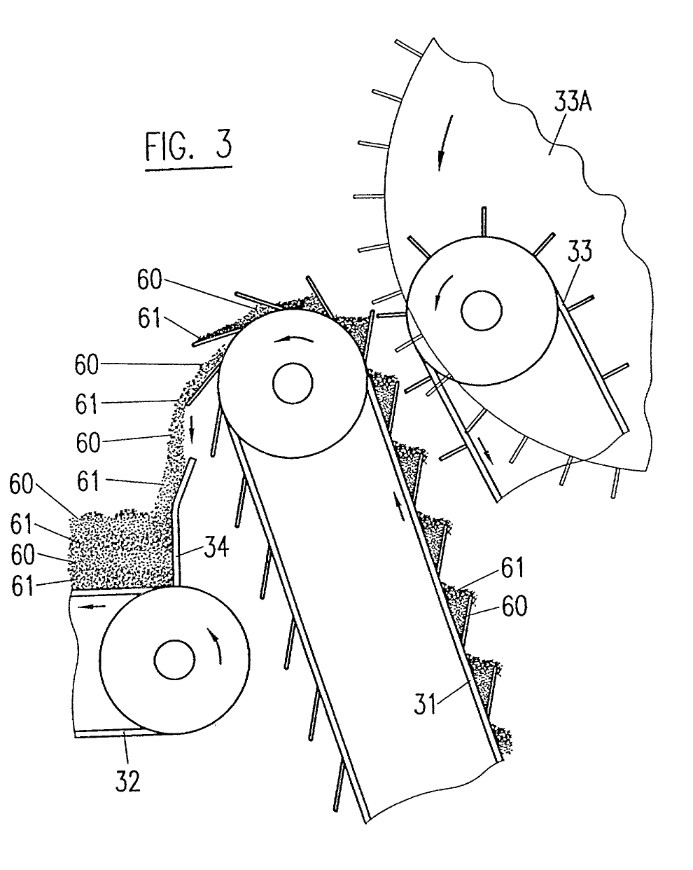

FIG. 3 shows in particular the first equalizing means—represented according to a first execution of a continuous belt 33 with flexible blades fixed perpendicularly and crosswise on the external surface of the belt and operating in the direction of the arrow—whose task is to collect the excessive tobacco fibers on the comb edges and unload them in the less-filled upper portions of the spaces between the combs, or to send the fibers back to the stock 30. The flexible blades of the belt 33 thus have a length that allows for their tips to meet the tips of the combs of the comb belt 31, to bend or give way during this encounter and push the excessive tobacco fibers toward the following comb. Preferably, the blade belt 33 is slanted toward the comb belt 31, its top, positioned toward the top of the comb belt 31 so that each comb of the belt 31 meets at least one of the flexible blades of the belt 33 on that portion of their common path.

Different execution of the first equalizing means can be envisaged. For example, the flexible blades can be positioned transversely according to a specific angle on the continuous belt 33, or be replaced by pliable spikes or, more generally, any component able to brush or scrape the upper edges of the combs of the comb belt 31. FIG. 3 shows by fine lines an execution where the continuous belt 33 is replaced by a roller 33A comprised of flexible blades as precedingly or as according to another of the described variants.

After the tobacco has passed by the top of the comb belt 31, it runs along the deflector 34, preferably by gravitation, eventually to be unloaded on the transfer belt 32. The deflector 34 here comprises a plate, serving to guide the tobacco stream in order to unload it on the transfer belt 32 according to a first direction. In FIG. 3, it is seen that as soon as the tobacco leaves the comb belt 31 and along the deflector 34, the stratification previously described for the comb belt 31 is the same: between portions of the tobacco stream comprising a high proportion of short fibers 60, respectively, portions of a high tobacco-fiber density, and portions of a high proportion of long fibers 61, respectively, portions of weaker tobacco density, meaning that these portions follow one another lengthwise in the direction of the tobacco stream, the stratification between these different portions being formed mostly perpendicularly to the tobacco stream. In the current hoppers, this type of distribution is kept up to the cigarette-making phase, resulting in cigarettes in which the distribution between short fibers 60 and long fibers 61 is not so accurately controlled.

As also shown in FIG. 3, the transfer belt 32 then takes the tobacco stream according to a second direction, mostly perpendicular, respectively, mainly nonparallel, to the first direction according to which the tobacco stream is brought on the transfer belt. The angle between the first and second directions lies between 90° and 120°, preferably close and slightly superior to 90°. Moreover, the forward speed of the transfer belt 32, meaning the speed at which the tobacco stream is run by the conveyor, is slow enough for the flow to be unloaded in a relatively thick layer on the transfer belt 32. In the example represented, this forward speed has been chosen in such a way that four of the successive portions of the aforementioned tobacco stream are superposed when the tobacco stream arrives on the transfer belt. FIG. 3 shows how the superposition of the portions with a high rate of short fibers 60, respectively, a high rate of long fibers 61, is produced along the transfer belt 32: the stratification between portions that was previously mostly transverse to the direction of the movement of the tobacco stream becomes mostly parallel to the direction of the movement of the tobacco stream on the transfer belt 32. In FIG. 3, the thickness of each portion, respectively, the entire layer of tobacco on the conveyor belt is strongly increased compared to the other dimensions of the system, in order to understand better this desired effect.

According to the preferential way of execution represented, the operating speed of the tobacco stream by the transfer belt 32 has been chosen so that four successive portions of the tobacco stream arriving on the conveyor are superposed in layers to form the thickness of the tobacco stream on the conveyor. The speed of the transfer belt 32 can also be chosen to obtain another number of layers different from four. What is important, in order to obtain the desired blending effect between portions by the means described below, is that this number exceed 1. The higher the number, the better the blend between portions of short fibers 60 and portions of long fibers 61. The execution with four layers represents an optimum in the quality of the resulting blend and the technical possibilities of the hopper. An odd number of layers might also be advantageous, for example three or five, the stratification between layers having thus already been destroyed on the transfer belt, each layer presenting an alternating succession of portions of short fibers 60 and portions of long fibers 61, the sequence of the portions being alternated between two superposed layers.

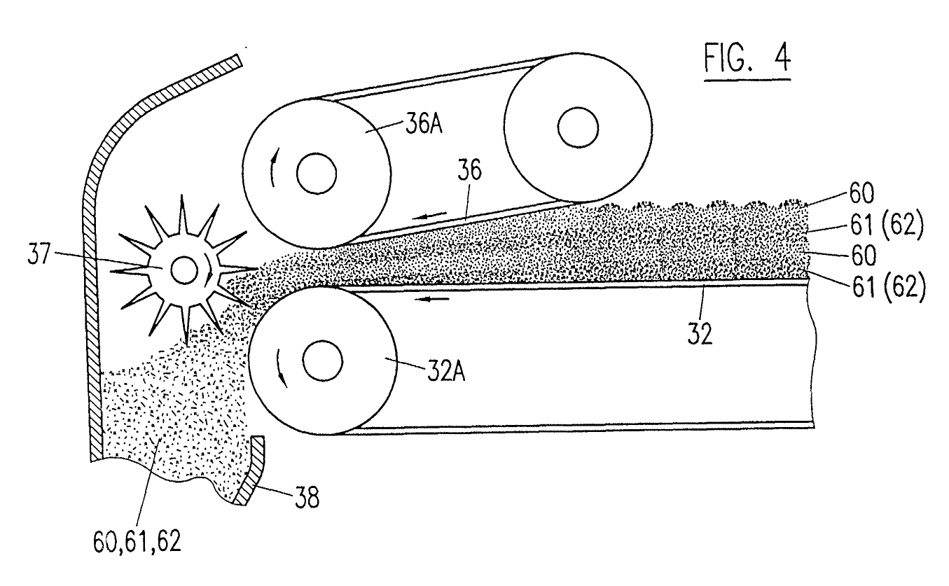

The transfer belt 32 moves the tobacco stream according to the direction of the arrow. When the tobacco stream leaves the transfer belt 32 as seen in FIG. 4, it is deblended, mixed and expanded by the spiked or barbed roller 37. For this it is preferable that the tobacco stream have a certain consistency. This consistency is obtained by the second equalizing means comprised of the continuous equalizing belt 36 whose driving side, directly in contact with the tobacco stream, runs in the same direction as the latter. The belt of the transfer belt 32 and that of the equalizing belt 36 are preferably made of the same pliable material, presenting a smooth upper surface with a certain adherence, especially for tobacco. The degree of adherence of the upper surface of the equalizing belt 36 as well as that of the transfer belt 32 can be chosen according to the composition or mixture of tobacco. The equalizing belt 36 and the transfer belt form a slight bevel, the smallest gap is directed toward the spiked or barbed roller 37, the section of the tobacco stream thus becoming progressively compressed at the end of its course on the transfer belt 32, passing by a narrowed space corresponding to a section of minimum gap predetermined between the closest portions of the equalizing belt 36 and the transfer belt 32. Preferably, this section of minimum gap can be adjusted, according to the composition or mixture of tobacco, by varying the distance between the axles of the 2 rollers 32A and 36A.

In addition, it is shown in FIG. 4 that the thickness of the layer of tobacco on the transfer belt 32 is not absolutely regular. Such irregularities stem from the discontinuous way in which the transfer belt 32 is fed with tobacco by the comb belt 31. If these irregularities in thickness were maintained, they could lead to undesired random variations in tobacco density of the finished cigarettes.

In order to eliminate these irregularities of thickness in the layer of tobacco on the transfer belt 32, the equalizing belt 36 is run at a slightly different speed than that of the transfer belt 32, respectively, from the tobacco stream on the latter. The difference in speed between the transfer belt 32 and the equalizing belt 36 can be positive or negative, meaning that the forward speed of the equalizing belt can be higher or lower than that of the transfer belt 32: the difference in speed ranging from +10% and −10% according to the composition or mixture of tobacco. In view of this difference in speed and the adherence of the tobacco on the equalizing belt 36, the extra thickness of the layer of tobacco in contact with the equalizing belt 36 is slowed down or accelerated and eventually fills the portions of less thickness.

When the tobacco stream leaves the transfer belt 32 and the equalizing belt 36, it presents a stratification between its portions or layers of a high proportion of long fibers, and its portions or layers of a high proportion of mostly longitudinal short fibers, respectively, parallel to the tobacco stream because of the difference between the first direction according to which the flow is brought onto the transfer belt 32 and the second direction according to which the flow is taken away by the transfer belt 32; the thickness of the tobacco stream presents several portions or layers of a high proportion of long fibers in-between several portions or layers of a high proportion of short fibers owing to the difference in speed between the running speed of the tobacco stream on the transfer belt 32 and the speed according to which this tobacco stream is brought onto the transfer belt. Moreover, the tobacco stream is relatively compact owing to the narrowing between the equalizing belt 36 and the transfer belt 32 as well as the uniform thickness, respectively, of average density because of the difference in speed between the equalizing belt 36 and the transfer belt 32.

When the tobacco stream is in this state, it undergoes a process of deblending, mixing and expanding; preferably a spiked or barbed roller 37, positioned through and within the path of the tobacco stream, and in rotation around an axle perpendicular to the displacement direction of the tobacco stream. By its rotating movement at high speed, preferably about 1 000 rpm according to the direction of the arrow in FIG. 4, the spiked or barbed roller 37 deblends the tobacco fibers and carries out a first separating of the midribs, winnowers and wastes having circulated so far in the tobacco stream; by the movement of the spikes transversely to both the flow and to the stratification mentioned between portions or layers of the tobacco stream of high proportion of long fibers 61 and portions of a high proportion of short fibers 60, a mixture is obtained of the portions mentioned, respectively a destruction of the stratifications mentioned, leading to a regular tobacco distribution of the various components of the tobacco stream, respectively, a regular distribution of both long and short fibers within the tobacco stream; and by introducing the tobacco stream into the upper portion of a transfer channel 38 presenting a section of tobacco stream distinctly higher than that mentioned previously encountered by the same flow between the equalizing belt 36 and the transfer belt 32, a strong section expansion of the tobacco stream, respectively, a strong decrease in tobacco density of the flow are obtained. The tobacco stream thus regulated, then follows the transfer channel 38, preferably by gravitation.

The part of the tobacco rod making, as seen in FIG. 1, comprises generally a suction chamber 40 drawing up pneumatically the tobacco through a suction belt 41 along a suction chimney 42 that, in the hopper execution described, comes out into a separating chamber 38A located in the central portion of the transfer channel 38, in such a way that the tobacco is formed into a rod under the suction belt 41. This rod forming part is generally completed by means of compression for rod portions, trimming, and wrapping with paper around the rod in accordance with practices which are well known in the art—various means not represented here.

Near the lower portion of the transfer channel 38, a suction entry 38B is provided through which the air drawn by the suction chamber 40 passes and mixes into the tobacco stream that still contains midribs, winnowers and wastes (such as pieces of stem) that come from the upper portion of the transfer channel. The tobacco fibers, midribs and winnowers of thin section, relatively light, are drawn up by the circulating air; they separate from the flow in the separating chamber 38A of the transfer channel 38, then progress by suction along the suction chimney 42. On the other hand, the midribs and winnowers of thicker section, and the wastes in the tobacco stream coming from the upper portion of the transfer channel 38—distinctly heavier than the tobacco fibers,—are not drawn into the suction chimney 42 but continue to fall because of gravity, to be recovered in a container or on a removal belt 39.

A mobile lock 43 has also been provided near the lower portion of the transfer channel 38, so that if the making machine or more specifically, the suction belt 41 is stopped, causing a break in the suction process or jams in the suction chimney 42, the tobacco stream still in motion in the upper portion of the transfer channel can be directed toward means of recovery 44 that will bring the tobacco back to the entry stock 30.

The machine 1 is equipped with motorized devices, outlined in 5, enabling the various mobile machine components to be driven. Technically well-known control means, outlined in 50, provide the various necessary controls for adjusting the running speeds of the various components, the control of the mobile lock 43 and the tangential lock 2. In general, the control means monitor these various components so as to maintain constant the tobacco stream in each part of the hopper. They react to various captors such as those mentioned: 24, 25 and 35.

A first advantage of such a hopper is thus to feed the chimney 42, respectively, the tobacco rod under the suction belt 41 with a tobacco stream of constant density, having a regular or even distribution of its components, notably, the short and long fibers; the irregularities having been removed in the way indicated above at the moment of the transit of the tobacco stream in the hopper.

A second advantage is that the tobacco fibers are never roughly handled, respectively, never damaged. In fact, the tobacco fibers are never propelled against a wall at high speed in order to separate them from the midribs, winnowers and wastes as in other known hoppers; the separating between tobacco fibers, midribs, winnowers and wastes is done gently, by suction of the tobacco fibers whereas the midribs, winnowers and wastes of thicker section, respectively, of more consequential mass, are separated from the flow by gravitation. The hopper according to the invention described does not use an air spray for such, ensuring therefore that the humidity of the tobacco fibers is not altered.

A third advantage of such a means of separation that it ensures a better separation of the tobacco fibers on the one hand, and the midribs, winnowers and wastes of thick section on the other hand, meaning that fewer midribs, winnowers and wastes are found in the tobacco rod and fewer tobacco fibers in the waste recovery of midribs, winnowers and wastes of thick section than in the hoppers of prior art.

A further advantage of such a hopper is that it enables an increase in production speed of the making machine for products of the tobacco industry. If it is assumed that from the time of the paper wrapping, the tobacco rod has a thickness of a value fixed at 100 according to a predetermined arbitrary scale, the inventors presently understand that—in order to take into account the compression of the portions of rod destined to form the cigarette ends—the rod is trimmed to a value of about 112 according to the same scale; no holes in the lower surface of the rod may therefore have a value lower than 112. In the making machines for products of the tobacco industry equipped with hoppers according to the prior art, that supply a tobacco stream of uncontrolled density in the chimney, in order to obtain this minimum value of rod thickness at 112, a tobacco stream is supplied in such a way that the maximum values of peaks on the rod before trimming go up to 140. Thus, there is a large quantity of tobacco, between 112 and 140 according to the scale mentioned, to be trimmed and recycled. On the other hand, for a making machine of products for the tobacco industry equipped with a hopper according to this invention, trials have shown that for a maximum value of peaks on the rod before trimming of 120, a minimum rod thickness of 112 is obtained. The quantity of tobacco to be trimmed and recycled is thus clearly decreased. Consequently, the tobacco stream supplied is better utilized and machine productivity is strongly increased.

Considering its small size and the minimal number of means necessary for its execution, such a hopper can easily be incorporated into a manufacturing machine for products of the tobacco industry, namely, a cigarette-making machine. Such a hopper can thus easily be installed in an actual making machine, in the place of a hopper of a former type and in view of the best tobacco-flow utilization mentioned, it is therefore possible to increase machine production speed for a predetermined tobacco stream.

While this invention has been illustrated and described in accordance with a preferred embodiment, it is recognized that variations and changes may be made therein without departing from the invention as set forth in the claims.

What is claimed is:

1. A process of feeding a tobacco stream from an entry stock of a hopper towards a suction chimney of a manufacturing machine for products of the tobacco industry, comprising the steps of:
moving a tobacco stream having repeating, successive portions, a first portion of the portions having a high proportion of short tobacco fibers and a second portion of the portions having a high proportion of long tobacco fibers longer than the short tobacco fibers, in a first direction and a at first speed to a transfer means;
supplying the tobacco stream to a conveyor moving in a second direction and at a second speed such that the tobacco stream has a form of a plurality of layers, at least one layer of the layers being a layer of short tobacco fibers and at least one layer of the layers being a layer of long tobacco fibers.

2. A process according to claim 1, wherein the second direction is substantially perpendicular to the first direction and the second speed is slower than the first speed.

3. A process according to claim 2, comprising the further steps of deblending, mixing, and expanding the tobacco stream after it is supplied to the conveyor.

4. A process according to claim 3, wherein the steps of deblending, mixing, and expanding of the tobacco stream are accomplished by turning a roller having projections thereon, an axis of the roller being disposed at a right angle to the second direction, such that the projections contact the tobacco stream.

5. A process according to claim 3, wherein the tobacco stream includes short tobacco fibers, long tobacco fibers, midribs, winnowers, and wastes, the method comprising the further steps of transporting the tobacco stream from the conveyor to a transfer channel such that the tobacco stream is disposed proximate a suction device, and supplying a sufficient suction force with the suction device to tend to separate the short tobacco fibers and the long tobacco fibers from the midribs, winnowers, and wastes by drawing the short tobacco fibers and the long tobacco fibers into the suction device as the midribs, winnowers, and wastes tend to fall by gravity toward a lower portion of the transport channel.

6. A process according to claim 2, comprising the further step compressing the tobacco stream after it is supplied to the conveyor.

7. A process according to claim 6, comprising the further steps of deblending, mixing, and expanding the tobacco stream after it is supplied to the conveyor.

8. A process according to claim 7, wherein the steps of deblending, mixing, and expanding of the tobacco stream are accom plished by turning a roller having projections thereon, an axis of the roller being disposed at a right angle to the second direction, such that the projections contact the tobacco stream.

9. A process according to claim 7, wherein the tobacco stream includes short tobacco fibers, long tobacco fibers, midribs, winnowers, and wastes, the method comprising the further steps of transporting the tobacco stream from the conveyor to a transfer channel such that the tobacco stream is disposed proximate a suction device, and supplying a sufficient suction force with the suction device to tend to separate the short tobacco fibers and the long tobacco fibers from the midribs, winnowers, and wastes by drawing the short tobacco fibers and the long tobacco fibers into the suction device as the midribs, winnowers, and wastes tend to fall by gravity toward a lower portion of the transport channel.

10. A process according to claim 1, comprising the further step compressing the tobacco stream after it is supplied to the conveyor.

11. A process according to claim 10, comprising the further steps of deblending, mixing, and expanding the tobacco stream after it is supplied to the conveyor.

12. A process according to claim 11, wherein the steps of deblending, mixing, and expanding of the tobacco stream are accomplished by turning a roller having projections thereon, an axis of the roller being disposed at a right angle to the second direction, such that the projections contact the tobacco stream.

13. A process according to claim 11, wherein the tobacco stream includes short tobacco fibers, long tobacco fibers, midribs, winnowers, and wastes, the method comprising the further steps of transporting the tobacco stream from the conveyor to a transfer channel such that the tobacco stream is disposed proximate a suction device, and supplying a sufficient suction force with the suction device to tend to separate the short tobacco fibers and the long tobacco fibers from the midribs, winnowers, and wastes by drawing the short tobacco fibers and the long tobacco fibers into the suction device as the midribs, winnowers, and wastes tend to fall by gravity toward a lower portion of the transport channel.

14. A hopper for a manufacturing machine for products of the tobacco industry, the hopper comprising:
a stock for holding tobacco, the tobacco including short tobacco fibers and long tobacco fibers longer than the short tobacco fibers;
a first conveyor having a movable first conveyor surface for transporting a tobacco stream from the stock of tobacco in a first direction, the first conveyor surface being movable at a first speed, such that the tobacco stream is in a form of repeating, successive portions, a first portion of the portions having a high proportion of the short tobacco fibers and a second portion of the portions having a high proportion of the long tobacco fibers, the first conveyor transporting the tobacco stream to an end of the first conveyor;
a second conveyor, the second conveyor having movable second conveyor surface extending between a first end and a second end, the first end being disposed proximate the end of the first conveyor and being arranged relative to the first conveyor to receive the tobacco stream from the end of the first conveyor so that the tobacco stream has a form of a plurality of layers, at least one layer of the layers being a layer of short tobacco fibers and at least one layer of the layers being a layer of long tobacco fibers, the second conveyor surface extending in a second direction and being movable at a second speed, the second direction and the second speed being different than the first direction and the first speed.

15. A hopper according to claim 14, wherein the first direction and the second direction form an angle between 90° and 120°, and the second speed is slower than the first speed.

16. A hopper according to claim 15, wherein the first conveyor includes a comb belt extending in the first direction and being movable at the first speed.

17. A hopper according to claim 16, further comprising a first equalizing means for equalizing a thickness of the tobacco stream on the first conveyor.

18. A hopper according to claim 17, wherein the first equalizing means includes a continuous belt with flexible protrusions extending therefrom, a flat portion of the continuous belt closest to the comb belt forming an angle with the comb belt, the flat portion being closer to the comb belt toward the end of the first conveyor than toward the stock, the comb belt having protrusions with tips, the flexible protrusions having tips that meet tips of the protrusions on the comb belt at least at one point, the continuous belt being movable so that a portion of the continuous belt closest to the comb belt moves in a direction mainly opposite to the first direction.

19. A hopper according to claim 17, wherein the first equalizing means includes a roller with flexible protrusions extending therefrom, the comb belt having protrusions with tips, the flexible protrusions having tops that meet the tips of the protrusion at least at one point, the roller being rotatable so that a portion of a surface of the roller closest to the comb belt moves in a direction mainly opposite to the first direction.

20. A hopper according to claim 18, further comprising a deflector disposed between the first conveyor and the second conveyor.

21. A hopper according to claim 17, further comprising a second equalizing means for equalizing a thickness of the tobacco stream on the second conveyor, the second equalizing means including a continuous belt disposed proximate the second end of the second conveyor, a portion of the continuous belt facing the second conveyor surface forming an angle with the second conveyor surface, the portion of the continuous belt facing the second conveyor surface being closer to the second conveyor surface proximate the second end of the second conveyor surface than proximate the first end of the second conveyor surface, the portion of the continuous belt facing the second conveyor surface being movable in substantially a same direction as the second direction at a continuous belt speed different from the second speed.

22. A hopper according to claim 21, wherein the second conveyor surface and a surface of the continuous belt are adherent with the tobacco.

23. A hopper according to claim 14, wherein the continuous belt speed is between +10% and −10% of the second speed.

24. A hopper according to claim 14, further comprising means for deblending, mixing and expansion of the tobacco stream proximate the second end of the second conveyor, the deblending, mixing and expansion means including a roller having protrusions thereon, the roller having an axis perpendicular to the second direction, a surface of the roller being rotatable at a roller speed faster than the second speed.

25. A hopper according to claim 24, further comprising a transfer channel through which the tobacco stream is adapted to travel after being conveyed to the second end of the second conveyor, the roller being disposed at an entry portion of the transfer channel.

26. A hopper according to claim 25, wherein the transfer channel is disposed below the second end of the second conveyor and the tobacco stream flows into the transfer channel from the second end of the second conveyor essentially by gravity.

27. A hopper according to claim 25, wherein the transfer channel includes a separating chamber including an opening at a bottom end of a suction chimney of a manufacturing machine for products of the tobacco industry, the manufacturing machine including a suction chamber for drawing a flow of air through a suction belt and the suction chimney, wherein the flow of air is set such that short tobacco fibers and long tobacco fibers of the tobacco stream in the separating chamber tend to be drawn in the suction chimney for collection under the suction belt to form a continuous tobacco rod, and midribs and winnowers and wastes in the tobacco stream tend to flow by gravity to a lower portion of the transfer channel.

28. A hopper according to claim 27, wherein the lower portion of the transfer channel includes means for disposal of the midribs and winnowers and wastes.

29. A hopper according to claim 27, wherein the lower portion of the transfer channel includes means for recovery of the tobacco stream and a mobile lock controlled to direct the tobacco stream toward the recovery means when suction by the suction chamber stops.

30. A hopper according to claim 14, wherein the first conveyor includes a comb belt extending in the first direction and being movable at the first speed.

31. A hopper according to claim 14, further comprising a first equalizing means for equalizing a thickness of the tobacco stream on the first conveyor.

32. A hopper according to claim 31, wherein the first equalizing means includes a continuous belt with flexible protrusions extending therefrom, a flat portion of the continuous belt closest to the comb belt forming an angle with the comb belt, the flat portion being closer to the comb belt toward the end of the first conveyor than toward the stock, the comb belt having protrusions with tips, the flexible protrusions having tips that meet tips of the protrusions on the comb belt at least at one point, the continuous belt being movable so that a portion of the continuous belt closest to the comb belt moves in a direction mainly opposite to the first direction.

33. A hopper according to claim 31, wherein the first equalizing means includes a roller with flexible protrusions extending therefrom, the comb belt having protrusions with tips, the flexible protrusions having tops that meet the tips of the protrusion at least at one point, the roller being rotatable so that a portion of a surface of the roller closest to the comb belt moves in a direction mainly opposite to the first direction.

34. A hopper according to claim 31, further comprising a second equalizing means for equalizing a thickness of the tobacco stream on the second conveyor, the second equalizing means including a continuous belt disposed proximate the second end of the second conveyor, a portion of the continuous belt facing the second conveyor surface forming an angle with the second conveyor surface, the portion of the continuous belt facing the second conveyor surface being closer to the second conveyor surface proximate the second end of the second conveyor surface than proximate the first end of the second conveyor surface, the portion of the continuous belt facing the second conveyor surface being movable in substantially a same direction as the second direction at a continuous belt speed different from the second speed.
